(19) United States
(12) Patent Application Publication
(10) Pub. No.: US 2021/0090194 A1
(43) Pub. Date: Mar. 25, 2021

(54) CART MANAGEMENT SYSTEM, CART MANAGEMENT SERVER, AND PROCESSING DEVICE

(71) Applicant: TOSHIBA TEC KABUSHIKI KAISHA, Tokyo (JP)

(72) Inventors: Yueye LI, Mishima Shizuoka (JP); Hiroyuki ISHIKAWA, Sunto Shizuoka (JP)

(21) Appl. No.: 17/005,203

(22) Filed: Aug. 27, 2020

(30) Foreign Application Priority Data
Sep. 24, 2019 (JP) 2019-172693

(51) Int. Cl. G06Q 50/28; G06Q 20/20; G06Q 30/06; G06K 7/14; G06K 7/10; H04W 4/029

(52) U.S. Cl. CPC G06Q 50/28; G06Q 20/208; G06Q 30/0623; G06F 3/0484; G06K 7/10366; H04W 4/029; G06K 7/1413

(57) ABSTRACT

A cart management system includes a processing device attached to a cart and a cart management server. The processing device includes a first communication interface, a position sensor interface connectable to a position sensor configured to detect a location thereof, a motion sensor interface connectable to a motion sensor configured to detect a motion thereof, and a first processor configured to control the first communication interface to transmit first information indicating the location detected by the position sensor and the motion detected by the motion sensor. The cart management server that includes a second communication interface and a second processor configured to, upon receipt of the first information from the processing device via the second communication interface, determine whether the cart is left unattended using the first information, and upon determining that the cart is left unattended, control the second communication interface to transmit a notification to a mobile terminal.

### CROSS-REFERENCE TO RELATED APPLICATIONS

This application is based upon and claims the benefit of priority from Japanese Patent Application No. 2019-172693, filed on Sep. 24, 2019, the entire contents of which are incorporated herein by reference.

### FIELD

Embodiments described herein relate generally to a cart management system, a cart management server, and a processing device.

### BACKGROUND

Conventionally, in a store such as a retail store, a customer uses a shopping cart for storing and carrying commodities and the like. The shopping cart is expected to be returned to a designated location by the customer after use. However, it is common for the user to leave the shopping cart at a different location such as a parking lot, which forces a store clerk to collect and return the shopping cart to the designated location.

Furthermore, in recent years, a shopping cart equipped with a checkout function, which is called “a cart point-of-sale (POS), has been developed and introduced. A commodity to be purchased is read (scanned) by the customer using a commodity reading device attached to the cart, and checkout of the read commodity can also be performed at the shopping cart. A store that has introduced such a multifunctional shopping cart has stronger need to make sure that such carts are returned to the designated place.

### BRIEF DESCRIPTION OF THE DRAWINGS

FIG. 1 is a diagram illustrating a cart management system according to an embodiment.

FIG. 2 is a block diagram of a server in a cart management system according to an embodiment.

FIG. 3 is a block diagram of a processing device in a cart management system according to an embodiment.

FIG. 4 is a sequence diagram of a first operation of a cart management system according to an embodiment.

FIG. 5 is a diagram illustrating a management-list for a server to manage each cart in a cart management system according to an embodiment.

FIG. 6 is a diagram illustrating a leave-list for a server to manage a left cart in a cart management system according to an embodiment.

FIG. 7 is a sequence diagram of a second operation of a cart management system according to an embodiment.

### DETAILED DESCRIPTION

In one embodiment, a cart management system includes a processing device attached to a cart and a cart management server. The processing device includes a first communication interface, a position sensor interface connectable to a position sensor configured to detect a location thereof, a motion sensor interface connectable to a motion sensor configured to detect a motion thereof, and a first processor configured to control the first communication interface to transmit first information indicating the location detected by the position sensor and the motion detected by the motion sensor. The cart management server that includes a second communication interface and a second processor configured to, upon receipt of the first information from the processing device via the second communication interface, determine whether the cart is left unattended using the first information, and upon determining that the cart is left unattended, control the second communication interface to transmit a notification to a mobile terminal.

Hereinafter, one or more embodiments will be described with reference to the drawings. First, a configuration of a cart management system 1 according to an embodiment will be described as an example.

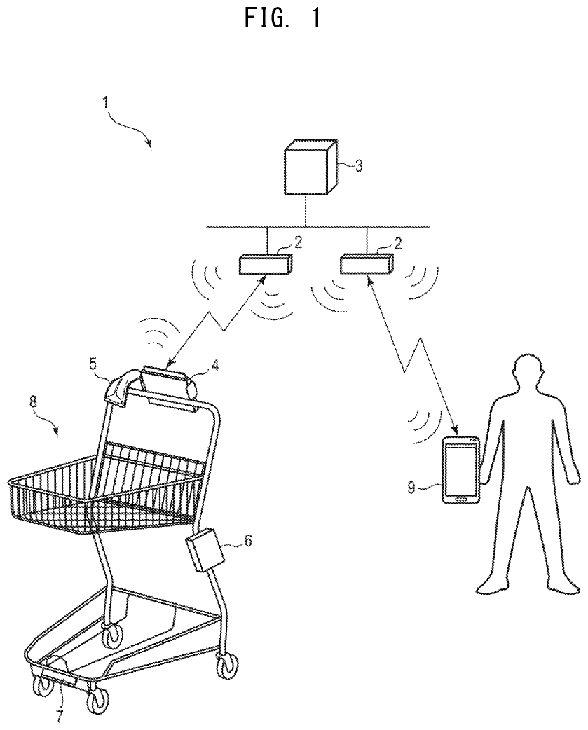

FIG. 1 is a schematic diagram of the cart management system 1. The cart management system 1 is a system for notifying staff of a position of a cart 8 that has been left unattended. Here, the cart management system 1 is assumed to be a system that manages the carts 8 used in a retail store or the like. In addition, it is assumed that a processing device 4 including an operation panel (as a user interface) is attached to each cart 8. The processing device 4 has a function of reading information of a commodity (that is, registering a commodity for inclusion in a sales transaction) placed in the cart 8 and a checkout function for making payment of each read/registered commodity. A cart equipped with a processing device 4 with at least one of a commodity reading function and a settlement function is referred to in this context as a cart POS.

In a configuration example illustrated in FIG. 1, the cart management system 1 includes a wireless communication device 2, a cart management server 3 (referred to as server 3, for simplicity), the processing device 4, and the like. The processing device 4 is mounted on a cart 8 together with a commodity reader 5, a motion sensor 6, and a position sensor 7. In general, any cart 8 having at least one of a commodity reading function and a checkout function, and on which the processing device 4, the commodity reader 5, the motion sensor 6, and the position sensor 7 are mounted, may be referred to as a cart POS.

The wireless communication device 2 relays communication between the server 3 and the processing device 4. In addition, the wireless communication device 2 relays communication between the server 3 and a mobile terminal 9. The wireless communication device 2 functions as, for example, an access point of a wireless LAN. In the configuration example illustrated in FIG. 1, the wireless communication device 2 is connected to the server 3 via a wired line. However, the wireless communication device 2 may be communicably connected to the server 3 in a wireless manner.

The server 3 is a management device for managing the cart POS. For example, the server 3 is installed in a store in which the cart POS is introduced. The server 3 communicates with the processing device 4 to acquire a usage state and position information of the cart POS. The server 3 transmits information indicating a cart POS which is being left unattended (e.g., a cart POS that is not being used, or a cart POS that is not returned to a designated position) to the mobile terminal 9. For example, the server 3 transmits position information of the cart POS being left to the mobile terminal 9 via the wireless communication device 2 through wireless communication.

The processing device 4 is attached to a frame of the cart 8 or the like. The processing device 4 has an operation panel as a user interface (UI) including a display device and an input operation device (e.g., a touch panel). The processing device 4 provides information to a user and receives an operation instruction from the user. The processing device 4 is connected to a commodity reader 5, such as a scanner for reading a barcode attached to a commodity or a tag reader for reading an RFID tag attached to a commodity. The processing device 4 has a function of displaying information corresponding to a commodity (e.g., a commodity name, a price, and the like) read by the commodity reader 5 and stored in the cart 8, and performing a checkout process on the commodity or commodities identified by the commodity reader 5.

The processing device 4 is connected to a motion sensor 6, such as an acceleration sensor, provided on the cart 8. The motion sensor 6 detects a movement of the cart 8. The motion sensor 6 is attached to the frame of the cart 8. The processing device 4 acquires an operation state or movement state of the cart 8 based on the information output by the motion sensor 6.

The processing device 4 is connected to a position sensor 7 for detecting the position of the cart 8. The position sensor 7 is, for example, a GPS sensor, but is not limited thereto. For example, the position sensor 7 may detect a position by receiving a signal from a beacon transmitted from within the store. The position sensor 7 is attached to the frame of the cart 8. The processing device 4 acquires position information of the cart 8 on the basis of the information output by the position sensor 7. The processing device 4 transfers information indicating the usage state and the position information of the cart POS to the server 3.

As shown in FIG. 1, the cart management system 1 may be a system including a mobile terminal 9. The mobile terminal 9 is an information processing device to which information indicating a cart POS has been determined as being left unused or misplaced is sent. The mobile terminal 9 is, for example, a terminal device possessed by a store clerk or other employee. For example, the mobile terminal 9 receives information from the server 3 via the wireless communication device 2, and displays the received information.

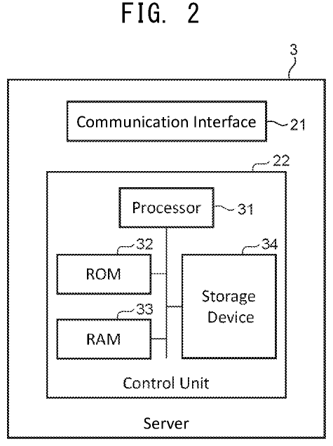

Next, a configuration of the server 3 will be described. FIG. 2 is a block diagram of the server 3. As shown in FIG. 2, the server 3 includes a communication interface 21 and a control unit 22. The communication interface 21 is an interface for communicating with other devices. For example, the communication interface 21 is connected to the wireless communication device 2 in a wired manner.

The communication interface 21 is configured to communicate with the processing device 4 via the wireless communication device 2. The communication interface 21 may be configured to perform wireless communication with the processing device 4 directly without the wireless communication device 2.

The communication interface 21 is configured to communicate with the mobile terminal 9 via the wireless communication device 2. The communication interface 21 may be configured to wirelessly communicate with the mobile terminal 9 directly without the wireless communication device 2.

The control unit 22 executes various types of processing in the server 3. The control unit 22 includes a processor 31, a ROM (read only memory) 32, a RAM (random access memory) 33, a storage device 34. The processor 31 is, for example, a CPU (central processing unit). The processor 31 performs various types of processing according to a program (s) stored in the ROM 32 or the storage device 34.

The ROM 32 is a read-only, non-volatile memory. For example, the ROM 32 stores a program, control data, and the like. The RAM 33 temporarily stores data. The storage device 34 is a rewritable non-volatile memory that stores data. For example, the storage device 34 is a hard disk drive (HDD), a solid state drive (SSD), or the like.

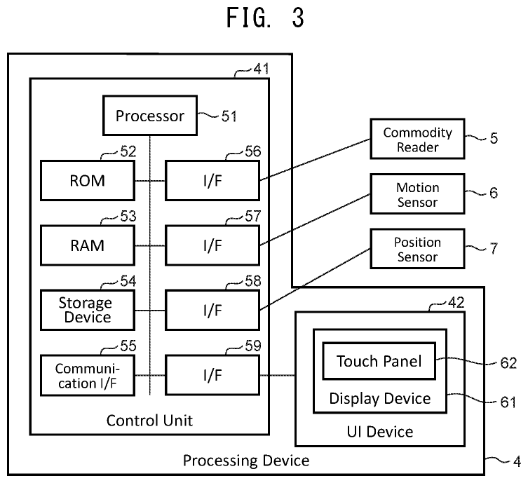

Next, a configuration of the processing device 4 will be described. FIG. 3 is a block diagram of the processing device 4. The processing device 4 includes a control unit 41 and a user interface (UI) unit 42. The control unit 41 executes various types of processing. In the configuration example illustrated in FIG. 3, the control unit 41 includes a processor 51, a ROM 52, a RAM 53, a storage device 54, a communication interface 55, and various interfaces (I/Fs) 56 to 59.

The processor 51 is, for example, a CPU. The processor 51 performs various types of processing according to a program(s) stored in the ROM 52 or the storage device 54.

The ROM 52 is a read-only non-volatile memory. For example, the ROM 52 stores a program(s) and control data. The RAM temporarily stores the data. The data memory 54 is a rewritable non-volatile storage device that stores data. The storage device 54 is, for example, an HDD or an SSD.

The communication interface 55 communicates with the server 3 via the wireless communication device 2. For example, the communication interface 55 transmits information such as position information and a usage state of the cart 8 collected by the processor 51 via the wireless communication device 2 to the server 3. In addition, the communication interface 55 may wirelessly communicate with the server 3 directly without the wireless communication device 2. Furthermore, the communication interface 55 may perform wireless communication with the mobile terminal 9 without the wireless communication device 2 and the server 3.

The interface 56 is an interface for connecting to the commodity reader 5, such as a scanner. The interface 57 is an interface for connecting a motion sensor 6, such as an acceleration sensor, to be attached to the cart 8. The interface 58 is an interface for connecting the position sensor 7 to be attached to the cart 8. The interface 59 is an interface for connecting the UI unit 42.

The UI unit 42 incorporates or connects to a device (e.g., an operation panel) that generates an operation signal according to an image display and a user input operation thereto or thereon. The UI unit 42 incorporates, for example, a display device 61 with a touch panel 62. For example, the display device 61 of the UI unit 42 displays data supplied from the control unit 41 or a graphics controller of the processing device 4. The touch panel 62 is an input operation device that receives an operation instruction from a user. The UI unit 42 may include a physical key or buttons, such as a numeric keypad, a keyboard, or the like. Furthermore, the UI unit 42 may incorporate a checkout device (e.g., a card reader) to be used for performing checkout on a commodity according to a user operation.

Next, a first operation of the cart management system 1 will be described. The first operation determines whether or not the cart 8 is in a “leave-state” (that is, an inactive, unused, and/or abandoned state) based on information collected from the cart 8 by the server 3. The server 3 notifies the mobile terminal 9 of information indicating a position of the cart 8 that is determined to be in the leave-state.

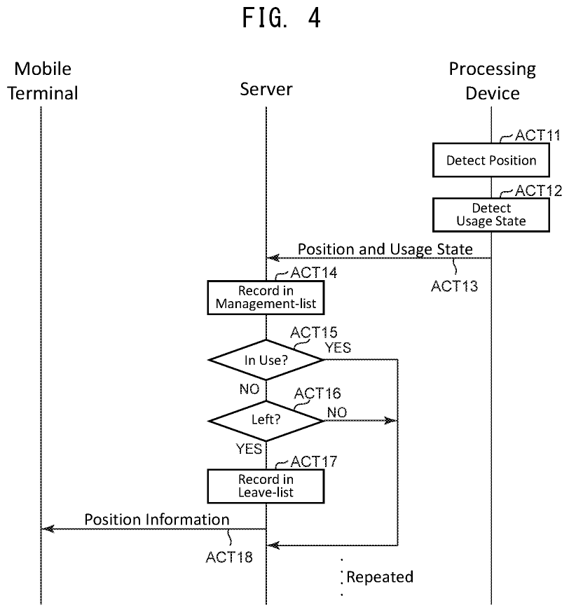

FIG. 4 is a sequence diagram of the first operation of the cart management system 1. First, the processor 51 of the processing device 4 detects a position and a usage state of the cart 8 in a predetermined cycle.

The processor 51 of the processing device 4 acquires position information detected by the position sensor 7. The processor 51 detects a position of the cart 8 based on the position information detected by the position sensor 7 (ACT 11). The position information may be a position coordinate detected by the GPS as the position sensor 7, or may be a position based on a beacon signal received by the position sensor 7.

The processor 51 of the processing device 4 acquires information detected by the motion sensor 6. The processor 51 determines a movement state of the cart 8 based on the information detected by the motion sensor 6. In addition to the movement state of the cart 8, the processor 51 detects a usage state of the cart based on whether or not a commodity is read by the commodity reader 5, whether or not an operation on the touch panel 62 of the UI unit 42 is performed, and the like (ACT 12). Upon detecting the position and the usage state, the processor 51 of the processing device 4 controls the communication interface 55 to transmit the detected position information and the usage-status-information to the server 3 (ACT 13).

The server 3 receives the usage-status-information and the position information from the processing device 4 by the communication interface 21. The processor 31 of the server 3 registers or updates a cart management list with information indicating the state of the cart 8 based on the position information and the usage state received from the processing device 4 (ACT 14).

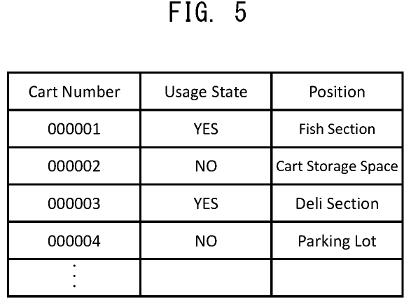

FIG. 5 is a diagram of the cart management list in which the server 3 accumulates information for managing carts. In an example illustrated in FIG. 5, the cart management list stores information such as identification information (e.g., a cart number), usage state, and position information of each cart to be managed. For example, the server 3 stores the cart number, the usage state, the position information of each cart received from the processing device 4, in the cart management list.

In the example illustrated in FIG. 5, information indicating whether the cart 8 is in use or stopped is recorded as the usage state of each cart. However, as the usage state, information for determining whether or not the cart 8 is in a state of being left may be recorded. For example, as the usage state, information indicating whether or not commodity information is read, whether or not the cart is moving, whether or not an input operation from the UI unit 42 of the processing device 4 is received, or the like may be stored.

In the example illustrated in FIG. 5, information indicating a position where the cart 8 is present in an area (for example, a fish section, a deli section, a cart storage space, a parking lot, or the like) is recorded as the position information of the cart 8. However, as the position information, information indicating a position or a location at which a clerk can find the cart 8 may be recorded. For example, position coordinates detected by the GPS as the position sensor or information indicating an installation position of the transmitter that transmits a beacon signal received by the position sensor may be recorded as position information.

When the information is registered or updated in the cart management list, the processor 31 determines whether the cart 8 registered in the cart management list is presently being used or not (ACT 15). When the cart 8 is presently being used (“in use”) (ACT 15, YES), the processor 31 omits process of ACT 16-18 since the cart 8 is not in the leave-state. Note that, the processor 31 may delete the information for the cart 8 that is being used from the cart management list.

If the cart is not being used (ACT 15, NO), the processor 31 next determines whether or not the cart 8 has been left unattended (ACT 16).

The processor 31 determines whether the cart is in the leave-state based on the usage-status-information and the position information recorded in the cart management list. For example, the processor 31 determines that any cart that is unused for at least some predetermined time and at a location other than some predetermined location (e.g., the cart storage space) is in a leave-state. The processor 31 may determine whether the cart is in the leave-state by generally considering whether or not commodity information has been recently read, whether or not the cart is moving or recently moved, whether or not a user input operation has been recently received via the UI unit 42, and the like.

If it is determined that the cart is not in the leave-state (ACT 16, NO), the processor 31 of the server 3 omits the processing of ACT 17-18, and ends the check of the leave-state for the cart. The processor 31 may delete the information of the cart(s) determined not to be in the leave-state from the cart management list.

When it is determined that the cart POS is in the leave-state (ACT 16, YES), the processor 31 registers the information of the cart POS in a leave-list (ACT 17). The leave-list records, for example, the position information of the cart POS determined to be in the leave-state.

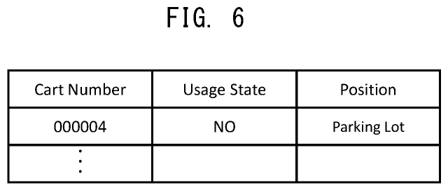

FIG. 6 is a diagram illustrating the leave-list for recording information indicating carts in the leave-state generated by the server 3. In the example illustrated in FIG. 6, the server 3 generates the cart management list including the cart number, the usage state, and the position information of the cart POS 8 received from the processing device 4. In the example illustrated in FIG. 6, information such as identification information (e.g., the cart number), the usage state, and the position information is stored in the leave-list for each cart determined to be in the leave-state. For example, the usage-status-information and the position information registered in the cart management list may be recorded in the leave-list as information about the cart in the leave-state.

In the example illustrated in FIG. 6, information indicating whether the cart is in unused state is recorded as the usage state. However, as the usage state, information indicating whether the commodity information is read, whether or not the cart is moving, whether or not an input operation has been received from the UI unit 42 of the processing device 4 or the like may be stored. Furthermore, in the example illustrated in FIG. 6, information indicating a position where a cart is left is provided as a name of an area (for example, a fish section, a deli section, a cart storage location, a parking lot, or the like) is recorded as the position information of the cart. However, as the position information, information indicating a position or a location at which a staff can find a cart that is determined to be in the leave-state may be recorded.

When the information on the cart determined to be in the leave-state is recorded in the leave-list, the processor 31 of the server 3 controls the communication interface 21 to transmit information for notifying the position of the cart determined to be the leave-state to the mobile terminal 9 (ACT 18). For example, the processor 31 controls the communication interface 21 to transmit the position information on the cart that is determined to be in the leave-state to the mobile terminal 9 as a notification destination set in advance by the communication interface 21.

The information indicating the position of the cart in the leave-state may be transmitted to a plurality of mobile terminals 9 possessed by a plurality of store clerks. The information recorded in the leave-list may be transmitted to the mobile terminal 9 in response to a request from the mobile terminal 9. In such a case, the server 3 may provide the mobile terminal 9 with information indicating the position of the left cart in response to the request from the clerk who is searching for the cart left unattended.

After a cart determined to be in the leave-state is moved to a predetermined location (e.g., a cart storage space), the store clerk may input, to the mobile terminal 9, that the cart has been stored in the predetermined location. In such a case, the mobile terminal 9 notifies the server 3 that the cart determined to be in the leave-state has been stored in the predetermined location. The processor 31 of the server 3 deletes the cart information stored in the predetermined location from the leave-list in response to the notification from the mobile terminal 9. This makes it possible to delete the information of the cart stored in the predetermined location from the leave-list.

As described above, the cart management system 1 determines whether or not a cart is in the leave-state based on the information collected from the processing device 4 of the cart 8 by the server 3. The server 3 notifies the mobile terminal 9 of information indicating the position of the cart 8 that is determined to be in the leave-state. In this way, the cart 8 which is left unattended and not being returned to the predetermined position can be identified based on the information collected from each cart 8 by the server 3. The server 3 can transmit the position of the cart 8 determined to be in the leave-state to the mobile terminal 9 possessed by a staff, and can notify the staff of the position of the cart 8 in the leave-state.

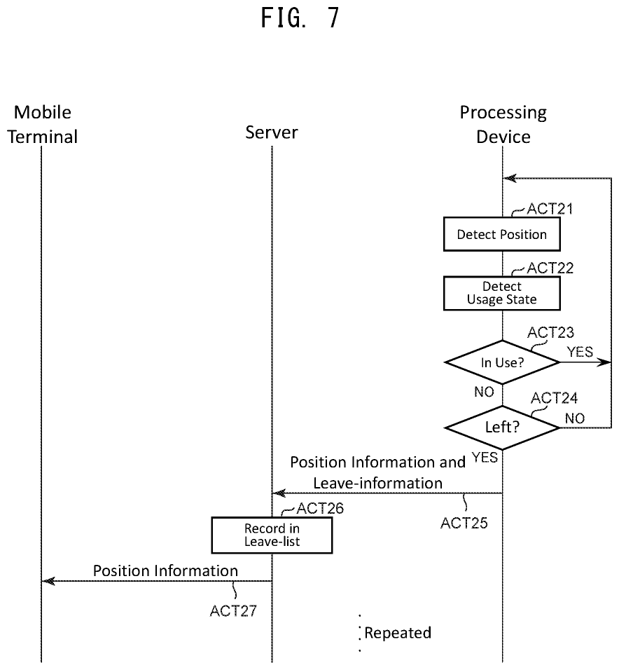

Next, a second operation of the cart management system 1 will be described. FIG. 7 is a sequence diagram of the second operation performed by the cart management system 1. First, the processor 51 of the processing device 4 detects a position and a usage state of a cart 8 in a predetermined cycle. The processor 51 acquires the position information detected by the position sensor 7, and detects the position of the cart 8 based on the position information detected by the position sensor 7 (ACT 21). The position information may be a position coordinate detected by the GPS as the position sensor 7, or may be a position based on a beacon signal received by the position sensor 7.

The processor 51 acquires the information detected by the motion sensor 6 and determines a movement state of the cart 8. In addition to the movement state of the cart 8, the processor 51 detects the usage state of the cart based on whether or not the commodity information has been recently read, whether or not the cart is moving or recently moved, whether or not an input operation on the touch panel 62 of the UI unit 42 has been recently performed, or the like (ACT 22).

When the usage state is detected, the processor 51 determines whether the cart is presently in use (ACT 23). When the cart is in use (ACT 24, YES), the processor 51 returns to ACT 21 because the cart is certainly not in the leave-state.

When the cart is in not in use (ACT 23, NO), the processor 51 then determines whether or not the cart is in the leave-state based on the detected position and the usage state (ACT 24). For example, the processor 51 determines that the cart is in the leave-state when the cart has been unused for at least some predetermined time and at a place other than a predetermined location, such as the designated cart storage location. In addition, the processor 51 may determine whether the cart is in the leave-state by generally considering whether or not commodity information has been recently read, whether or not the cart is recently moved, whether or not an input operation has been received via the UI unit 42, and the like.

When it is determined that the cart is not in the leave-state (ACT 24, NO), the processor 51 returns to ACT 21, and repeatedly executes the check of the leave-state based on the position and the usage state. When it is determined that the cart is in the leave-state (ACT 24, YES), the processor 51 controls the communication interface 55 to transmit, to the server 3, information indicating that the cart is in the leave-state together with the position information of the cart (ACT 25). Here, the processor 51 may control the communication interface 55 to transmit the usage-status-information together with the leave-information to the server 3.

The server 3 receives the position information and the leave-information from the processing device 4 by the communication interface 21. Upon receiving the position information and the leave-information, the processor 31 of the server 3 registers the position information of the cart POS in the leave-list (ACT 26). The processor 31 records, for example, the position information of the cart determined to be in the leave-state in the leave-list.

When the position information of the cart determined to be in the leave-state is recorded in the leave-list, the processor 31 of the server 3 controls the communication interface 21 to transmit information for notifying the position of the cart determined to be the leave-state to the mobile terminal 9 (ACT 27). For example, the processor 31 controls the communication interface 21 to transmit the position information on the cart that is determined to be in the leave-state to the mobile terminal 9, which has been set as a notification destination in advance.

Similarly to the first operation, information indicating the position of the cart in the leave-state may be transmitted to a plurality of mobile terminals 9 possessed by a plurality of store clerks. The information recorded in the leave-list may be transmitted to the mobile terminal 9 in response to a request from the mobile terminal 9. In such a case, the server 3 can provide information indicating the position of the cart that has been left unattended to the clerk who is searching for the cart left unattended.

After the cart determined to be in the leave-state is stored in a predetermined location (e.g., a cart storage space), the store clerk may input, to the mobile terminal 9, that the cart has been stored in the predetermined location. In such a case, the mobile terminal 9 notifies the server 3 that the cart determined to be in the leave-state has been stored in the predetermined location. The processor 31 of the server 3 deletes the cart information stored in the predetermined location from the leave-list in response to the notification from the mobile terminal 9. This makes it possible to delete the information of the cart stored in the predetermined location from the leave-list.

As described above, in the cart management system 1, the processing device 4 mounted on each cart determines whether the cart is in the leave-state based on the cart position and the usage state of the cart. The server 3 acquires the position information and the leave-information from the processing device 4 determined to be in the leave-state, and notifies the mobile terminal 9 of the position of the cart in the leave-state. Accordingly, it is possible to detect that each cart POS is left unattended and is not returned to the predetermined position. The server 3 transmits the position of the cart determined to be in the leave-state to the mobile terminal 9 possessed by a store clerk, and can notify the clerk of the position of the cart in the leave-state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cart management system, comprising:
a processing device attached to a cart and including:
a first communication interface,
a position sensor interface connectable to a position sensor configured to detect a location thereof,
a motion sensor interface connectable to a motion sensor configured to detect a motion thereof, and
a first processor configured to control the first communication interface to transmit first information indicating the location detected by the position sensor and the motion detected by the motion sensor; and
a cart management server including:
a second communication interface, and
a second processor configured to:
upon receipt of the first information from the processing device via the second communication interface, determine whether the cart is left unattended using the first information, and
upon determining that the cart is left unattended, control the second communication interface to transmit a notification to a mobile terminal.

2. The cart management system according to claim 1, wherein
the processing device further includes:
a reader interface connectable to a commodity reader, and
a display interface connectable to a display, and the first processor is further configured to:
control the commodity reader to read a symbol on a commodity, and
control the display to display commodity information about the commodity based on the read symbol.

3. The cart management system according to claim 1, wherein
the cart management server further includes a memory, and
the second processor is further configured to:
determine an area in a store where the cart is located using the first information, and
store in the memory the determined area in association with second information about whether the cart is left unattended.

4. The cart management system according to claim 1, wherein the second processor determines that the cart is left unattended when the location indicated by the first information has not changed for a predetermined time.

5. The cart management system according to claim 1, wherein the second processor determines that the cart is left unattended when the location indicated by the first information is not a predetermined location.

6. The cart management system according to claim 1, wherein
the processing device further includes an operation panel,
the first processor is further configured to control the first communication interface to transmit an operation state of the operation panel to the cart management server, and
the second processor determines whether the cart is left unattended further using the operation state.

7. The cart management system according to claim 1, wherein the processing device is attached to a handle of the cart.

8. The cart management system according to claim 1, further comprising:
a communication device by which the first information transmitted from the processing device is relayed to the cart management server.

9. The cart management system according to claim 8, wherein the notification transmitted from the cart management server is relayed to the mobile terminal via the communication device.

10. The cart management system according to claim 1, wherein the first processor is further configured to:
determine whether the cart is left unattended based on the detected location and motion, and
control the first communication interface to transmit to the cart management server the detected location and third information indicating whether the cart is left unattended.

11. A cart management server, comprising:
a memory that stores an address of a mobile terminal;
a communication interface; and
a processor configured to:
acquire, from a processing device attached to a cart via the communication interface, first information that indicates a location and a motion of the processing device,
determine whether the cart is left unattended using the acquired first information, and
upon determining that the cart is left unattended, control the communication interface to transmit a notification to the mobile terminal, using the stored address.

12. The cart management server according to claim 11, wherein the processor is further configured to:
determine an area in a store where the cart is located using the first information, and
store in the memory the determined area in association with second information indicating whether the cart is left unattended.

13. The cart management server according to claim 11, wherein the processor determines that the cart is left unattended when the location indicated by the first information has not changed for a predetermined time.

14. The cart management server according to claim 11, wherein the processor determines that the cart is left unattended when the location indicated by the first information is not a predetermined location.

15. The cart management server according to claim 11, wherein the processor acquires an operation state of an operation panel of the processing device, and determines whether the cart is left unattended further using the operation state.

16. The cart management server according to claim 11, wherein the processing device is attached to a handle of the cart.

17. A processing device to be attached to a cart, the processing device comprising:
a communication interface;
a position sensor interface connectable to a position sensor configured to detect a location thereof;
a motion sensor interface connectable to a motion sensor configured to detect a motion thereof; and
a processor configured to:
control the position sensor to detect the location via the position sensor interface,
control the motion sensor to detect the motion via the motion sensor interface,
determine whether the cart is left unattended based on the detected location and motion, and
upon determining that the cart is left unattended, control the communication interface to transmit to a cart management server the detected location and first information indicating whether the cart is left unattended.

18. The processing device according to claim 17, further comprising:
a reader interface connectable to a commodity reader; and
a display interface connectable to a display, wherein
the processor is further configured to:
control the commodity reader to read a symbol on a commodity via the reader interface, and
control, via the display interface, the display to display commodity information about the commodity based on the read symbol.

19. The processing device according to claim 18, wherein the display includes a touch panel, and the processor determines that the cart is left unattended when the touch panel has not been operated for a predetermined time.

20. The processing device according to claim 17, wherein the processing device is attached to a handle of the cart.
